(19) United States
(12) Patent Application Publication
(10) Pub. No.: US 2025/0104687 A1
(43) Pub. Date: Mar. 27, 2025

(54) ACTIVE CANCELLATION OF NOISE FROM MOTION SENSOR SIGNALS

(71) Applicant: Apple Inc., Cupertino, CA (US)

(72) Inventors: Christopher C. Painter, Dublin, CA (US); Axit H. Patel, Sunnyvale, CA (US); Joshua D. Atkins, Lexington, MA (US); Moshe H. Malkin, Menlo Park, CA (US); Nicholas C. Soldner, Los Altos, CA (US); Robert D. Silfvast, Belmont, CA (US); Zhengrong Shang, Pacifica, CA (US); Timo Birnschein, Redwood City, CA (US); Qinghung Lee, Monte Sereno, CA (US)

(21) Appl. No.: 18/895,319

(22) Filed: Sep. 24, 2024

Related U.S. Application Data
(60) Provisional application No. 63/540,342, filed on Sep. 25, 2023.

(51) Int. Cl. G10K 11/178

(52) U.S. Cl. CPC G10K 11/17873; G10K 11/17854; G10K 2210/129

(57) ABSTRACT

Embodiments are disclosed for active cancellation of noise in motion sensor signals. In some embodiments, a method comprises: obtaining a motion sensor signal from a motion sensor; obtaining a reference signal indicative of parasitic vibration from a vibration source mechanically coupled to the motion sensor; generating, using an adaptive noise canceller, an estimate of the parasitic vibration; and using the estimated parasitic vibration to cancel the parasitic vibration from the motion sensor signal.

### CROSS-REFERENCE TO RELATED APPLICATION

This application claims priority to U.S. Provisional Patent Application No. 63/540,342, filed Sep. 25, 2023, the entire contents of which are incorporated herein by reference.

### TECHNICAL FIELD

This disclosure relates generally to cancelling noise from motion sensor signals.

### BACKGROUND

Inertial measurement units (IMUs) or other motion sensors inside platforms (e.g., smartphones, table computers, head mounted devices) including inertial measurement units or other motion sensors are impacted by other structurally coupled subsystems such as speakers or haptic actuators. Typically, the vibrations induced by loudspeakers or haptic actuators are filtered out using classical low, band or high-pass filters which can be detrimental to motion signal bandwidth and latency, and also may not fully suppress the disturbances. Additionally, restricting the concurrent use of those subsystems and the motion sensors degrades user experience.

### SUMMARY

Embodiments are disclosed for active cancellation of noise from motion sensor signals.

In some embodiments, a method comprises: obtaining a motion sensor signal from a motion sensor; obtaining a reference signal indicative of parasitic vibration from a vibration source mechanically coupled to the motion sensor;
generating, using an adaptive noise canceller, an estimate of the parasitic vibration; and
using the estimated parasitic vibration to cancel the parasitic audio vibration from the motion sensor signal.

In some embodiments, the reference signal is proportional to the parasitic vibration.

In some embodiments, the reference signal is a music file that has been equalized or filtered.

In some embodiments, the reference signal is an analog signal.

In some embodiments, the adaptive noise canceller includes an adaptive filter, and coefficients of the adaptive filter are programmable.

In some embodiments, a system comprises: at least one motion sensor configured to sense motion in at least one direction, and output a signal proportional to the sensed motion; a voltage converter configured to convert the sensed signal into a voltage signal; an analog-to-digital converter configured to convert the analog voltage signal into a digital signal; and a disturbance estimator configured to estimate a disturbance signal included in the digital signal due to parasitic vibration generated by a vibration source mechanically coupled to the at least one motion sensor; a subtraction unit configured to subtract the estimated disturbance signal from the digital signal; and a circuit configured to provide the digital signal to at least one application.

In some embodiments, the disturbance estimator is a digital active noise canceller that receives the digital signal and a digital reference input that is proportional to the disturbance, and iteratively computes the estimated disturbance signal based on an error between the digital signal and the estimated disturbance signal.

In some embodiments, the disturbance estimator is an analog active noise canceller that receives the voltage signal and an analog reference input that is proportional to the disturbance, and iteratively computes the estimated disturbance signal based on an error between the voltage signal and the estimated disturbance signal.

In some embodiments, the active noise canceller includes an adaptive filter, and coefficients of the adaptive filter are programmable.

In some embodiments, a system comprises: a mounting platform; at least one motion sensor mounted on the mounting platform and configured to sense motion in at least one direction, and output a signal proportional to the sensed motion; a vibration source mechanically coupled to the mounting platform; a controller configured to generate vibrations that also incur disturbances mechanically coupled to the motion sensor through the mounting platform; a voltage converter configured to convert the sensed motion into a voltage signal; an analog-to-digital converter configured to convert the analog voltage signal into a digital motion signal; and a disturbance estimator configured to estimate a disturbance signal included in the digital motion signal due to parasitic vibration generated by the vibration source mechanically coupled to the at least one motion sensor; a subtraction unit configured to subtract the estimated disturbance signal from the digital signal; and a circuit configured to provide the digital motion signal to at least one application.

In some embodiments, the disturbance estimator is a digital active noise canceller that receives the digital motion signal and a vibration source reference that is proportional to the disturbance, and iteratively computes the estimated disturbance signal based on an error between the measured digital motion signal and the estimated disturbance signal.

In some embodiments, the active noise canceller includes an adaptive filter, and coefficients of the adaptive filter are programmable.

In some embodiments, the disturbance estimator is an analog active noise canceller that receives the voltage signal and an analog reference input that is proportional to the disturbance, and iteratively computes the estimated disturbance signal based on an error between the voltage signal and the estimated disturbance signal.

In some embodiments, a system comprises: at least one motion sensor configured to sense motion in at least one direction, and output a signal proportional to the sensed motion; a vibration source mechanically coupled to the motion sensor; a controller configured to generate a reference signal proportional to a disturbance due to parasitic vibration generated by the vibration source; a voltage converter configured to convert the sensed motion into a voltage signal; a disturbance estimator configured to estimate a disturbance signal included in the voltage signal due to parasitic vibration; a subtraction unit configured to subtract the estimated disturbance signal from the voltage signal; an analog-to-digital converter configured to convert the voltage signal into a digital signal; and a circuit configured to provide the digital signal to at least one application.

In some embodiments, the disturbance estimator receives the voltage signal and reference voltage input that is proportional to the disturbance and determines the estimated disturbance signal based on an error between the voltage signal and the estimated disturbance signal.

In some embodiments, any of the preceding systems is included in a head mounted device and the at least one motion sensor senses motion of the head mounted device.

Other embodiments are directed to an apparatus, system and computer-readable medium.

Particular embodiments described herein provide one or more of the following advantages. This disclosed system and method incorporates analog or digital signals from a platform, or other source, to actively remove unwanted signals from motion sensor signals. The system/method can use digital signals, such as audio buffers, as an error or “disturbance” signal input or other sensors (e.g., microphones) as an input error source.

The removal of unwanted signals from motion sensor signals benefits applications such as mobile phones, tablets and head mounted devices where clean motion sensor data is crucial to enable stable virtual and mixed reality experiences while audio or other co-existing sources (e.g., haptic actuators, voice coils) are active. It is not desired to turn off audio or other sources on a head mounted device since audio and the other sources may be a crucial part of the immersive experience.

### BRIEF DESCRIPTION OF THE DRAWINGS

FIG. 1 illustrates introduction of noise generated by a vibration source into 3-axis accelerometer measurements, according to one or more embodiments.

FIG. 2 is a conceptual block diagram illustrating the problem statement, according to one or more embodiments.

FIG. 3 is a conceptual block diagram of a system for active cancellation of noise from motion sensor signals, according to one or more embodiments.

FIG. 4 is a flow diagram of a process of active cancellation of noise from motion sensor signals, according to one or more embodiments.

FIG. 5 is a block diagram of a device architecture for implementing the features and processes described in reference to FIGS. 1-4.

FIG. 6 is a block diagram of a system for synchronizing IMU module clock to a system clock, according to one or more embodiments.

FIG. 7 is a block diagram of a system for synchronizing a system clock to an IMU module clock, according to one or more embodiments.

FIG. 8 is a conceptual block diagram of a system for active cancellation of noise from motion sensor signals, where the subtraction of the estimated parasitic vibration from the motion signal occurs at the output of the IMU module, according to one or more embodiments.

### DETAILED DESCRIPTION

### Problem Statement

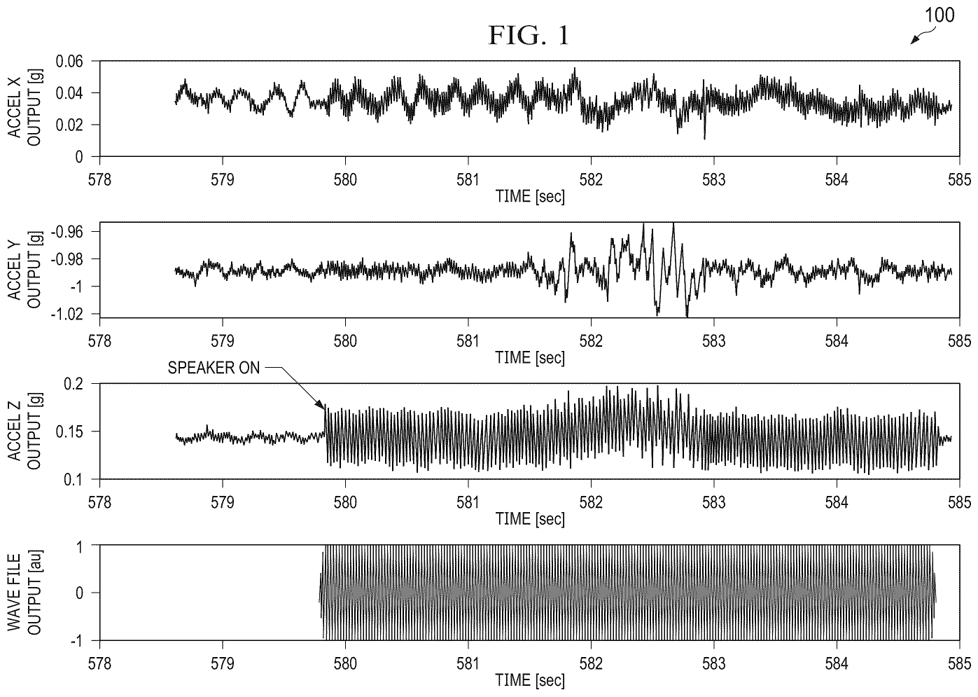

FIG. 1 illustrates introduction of noise generated by a vibration source into 3-axis accelerometer measurements, according to one or more embodiments. Some examples of vibration sources include but are not limited to loudspeakers, voice coils and haptic actuators. The plots from top to bottom include motion (e.g., acceleration) measurements on orthogonal x, y, and z axes, respectively, and the bottom plot shows a normalized waveform file output. As indicated in the figure when the vibration source (in this example a loudspeaker) is turned on parasitic vibration is introduced in the motion sensor measurements due to the mechanical coupling of the parasitic vibration to the motion sensors through a structure, e.g., a printed circuit board. This added noise in motion sensor output can impact the performance of a device or application that relies on accurate motion sensing (e.g., head tracking application for virtual or augmented reality applications). Note that gyroscope measurements can be disturbed in a similar way.

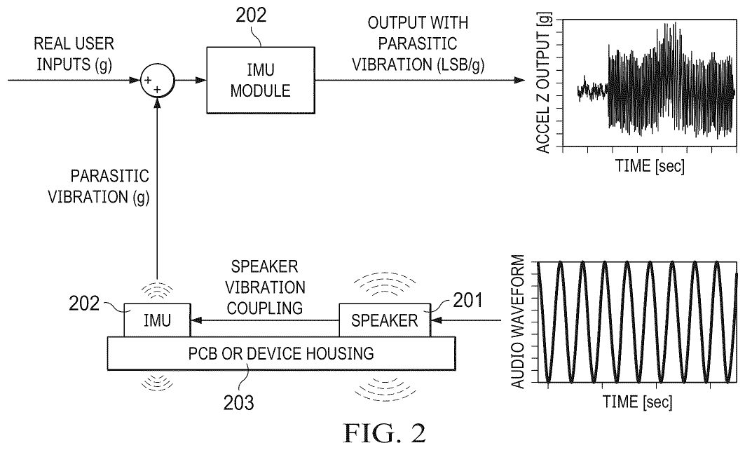

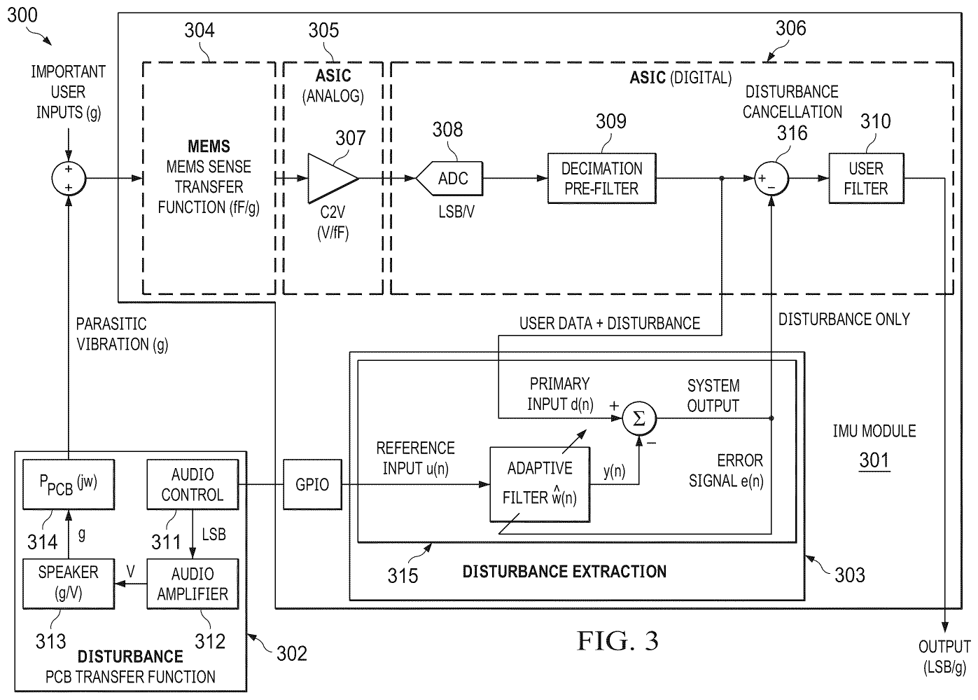

FIG. 2 is a conceptual block diagram illustrating the problem statement, according to one or more embodiments. In this example, the vibration source is shown as loudspeaker 201. In general, loudspeaker can be replaced with a vibration source 201, which includes any vibration source including but not limited to a loudspeaker and a haptic engine. Referring to the bottom of FIG. 2, when an audio waveform is played through vibration source 201 of a device (e.g., a head mounted device), the vibrations are mechanically coupled to inertial measurement unit (IMU) module 202 mounted on printed circuit board (PCB) 203. This parasitic vibration is added to the user motion input resulting in a disturbed motion sensor signals as shown in FIG. 1. Typically, a digital filter is included in IMU module 202 that is designed to filter out the parasitic vibration form the motion signal. However, there are tradeoffs between latency and filtering effectiveness of the digital filter such that applications with low latency demands cannot effectively filter out all the parasitic vibration. This results in a motion sensor signal that still includes parasitic vibration. The plot of the output of IMU module 202 illustrates that not all the parasitic vibration is removed from the motion signal by the digital filter in IMU module 202 because user motion needs to be preserved and filtering reduces latency. A system that removes the parasitic vibration from the motion sensor signal with reduced latency is described in reference to FIG. 3.

### Example System

FIG. 3 is a conceptual block diagram of a system 300 for active cancellation of noise from motion sensor signals, according to one or more embodiments. System 300 is divided conceptually into three sections: motion sensor module 301 (202 in FIG. 2), disturbance 302 and disturbance extraction 303. Each section is described below in turn.

Motion sensor module 301 (e.g., an IMU module) represents an exemplary processing path for a motion sensor signal, such as, for example, an acceleration signal from a 3-axis micro-electrical mechanical systems (MEMS) accelerometer. The processing path shown is for a single axis and includes MEMS accelerometer 304, analog application-specific integrated circuit (ASIC) 305 and digital ASIC 306. A similar processing path would be used for the other two axes.

Within the example processing path shown, motion sensor 304 is a single axis accelerometer that senses inertial acceleration and outputs a capacitance proportional to the sensed inertial acceleration along a specific sensing direction. However, the disclosed embodiments are also suited for a gyroscope application. The capacitance is converted to a voltage in analog ASIC 305 by a capacitance-to-voltage (C2V) converter 307. The voltage is converted to digital data by analog-to-digital converter (ADC) 308 in digital ASIC 306. The digital signal is then optionally processed by decimation filter 309 (e.g., a cascaded integrator comb (CIC) pre-filter) to reduce the sample rate of the motion sensor signal. The output of decimation filter 309 is a digital representation of the disturbed motion sensor signal. An estimate of the disturbance provided by disturbance extraction section 303 is subtracted from the disturbed motion sensor signal by a subtraction unit and the remaining motion sensor signal is optionally input into a second decimation filter 310 that further reduces the sample rate for use by applications.

Referring to the disturbance section 302 of system 300, there is audio control 311, audio amplifier 312, loudspeaker 313 and mounting structure transfer function 314. Disturbance section 302 conceptually represents a disturbance channel where parasitic vibration is generated and coupled to the user motion inputs through mechanical coupling, as shown in FIG. 2. In this example embodiment, audio control 311 sends an audio signal to audio amplifier 312, which drives loudspeaker 313. The vibration of loudspeaker 313 creates parasitic vibration (acceleration in units of g) which is mechanically coupled 314 to motion sensor module 301 through mounting platform 203 (see FIG. 2) which is represented by mounting platform transfer function 314 in FIG. 3. Mounting platform transfer function 314 indicates an unknown transfer function block that relates vibration at the loudspeaker 313 location to vibration at the motion sensor module 301 mounted on mounting platform 203. The contributions of mounting platform 203 to the disturbance channel are accounted for by mounting platform transfer function 314. The estimation of mounting platform transfer function 314 and the other components in the disturbance channel is performed in the disturbance extraction section 303 to cancel the disturbance. An example mounting platform 203 is a PCB but can be any structure coupled to the motion sensor module 301.

In some embodiments, audio control 311 generates a reference signal that is used by the disturbance extraction section 303 to cancel the disturbance. In some embodiments, the reference signal is proportional to the disturbance output such that it can be used to actively cancel the parasitic vibration from the motion sensor signal. The units of the reference input, in this example, are digital bits. In some embodiments, audio control 311 outputs a music file (WAV file) that has been equalized and/or filtered to become the audio control signal for audio amplifier 312 and the reference input. In other embodiments, the reference input signal can be an analog signal.

The disturbance extraction section 303 includes adaptive noise canceller 315 which, in one embodiment, takes as input the digital signal from the anywhere in the digital data path (e.g., after ADC 308) and the reference signal and extracts the disturbance portion of the motion signal, which is then subtracted by subtraction unit 316 (i.e., “cancelled”) from the motion sensor signal at the output of decimation filter 309. In other embodiments, the adaptive noise canceller 315 takes as input the output of digital ASIC 306. In other embodiments, the adaptive noise canceller 315 is replaced with one or more fixed filters.

In some embodiments, adaptive noise canceller 315 is included in motion sensor module 301 and includes a self-adjusting adaptive filter which automatically transforms the reference input signal into an optimal estimate of the parasitic vibration before subtracting 316 the optimal estimate of the parasitic vibration from the motion sensor signal, thereby reducing the impact of the parasitic vibration on the motion sensor signal. In some embodiments, adaptive noise canceller 315 adjusts its coefficients (weights) iteratively to minimize the residual disturbance or error (e (n) in FIG. 3) affecting the motion sensor signal.

To reduce the latency caused by adaptive noise canceller 315, in some embodiments the adaptive filter coefficients are registers/values that are programmable. In other embodiments, adaptive noise canceller 315 is implemented in software in a microcontroller or other suitable processor (e.g., a digital signal processor). In some embodiments, the adaptive filter coefficients are trained during manufacture and stored in memory or hardware registers (or fused if a field programmable gate array (FPGA) is used) and used throughout the in-field life of the device. In other embodiments, the filter coefficients are adapted in-field periodically and/or in response to certain trigger conditions (e.g., to overcome shifts over life, temperature, etc.).

### Example Process

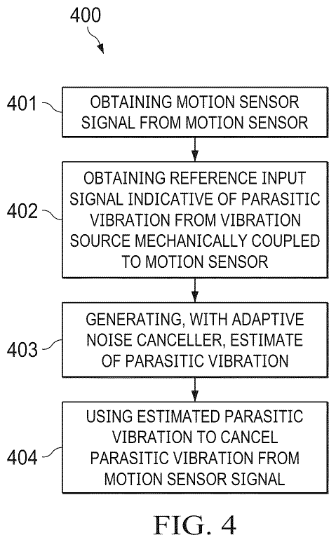

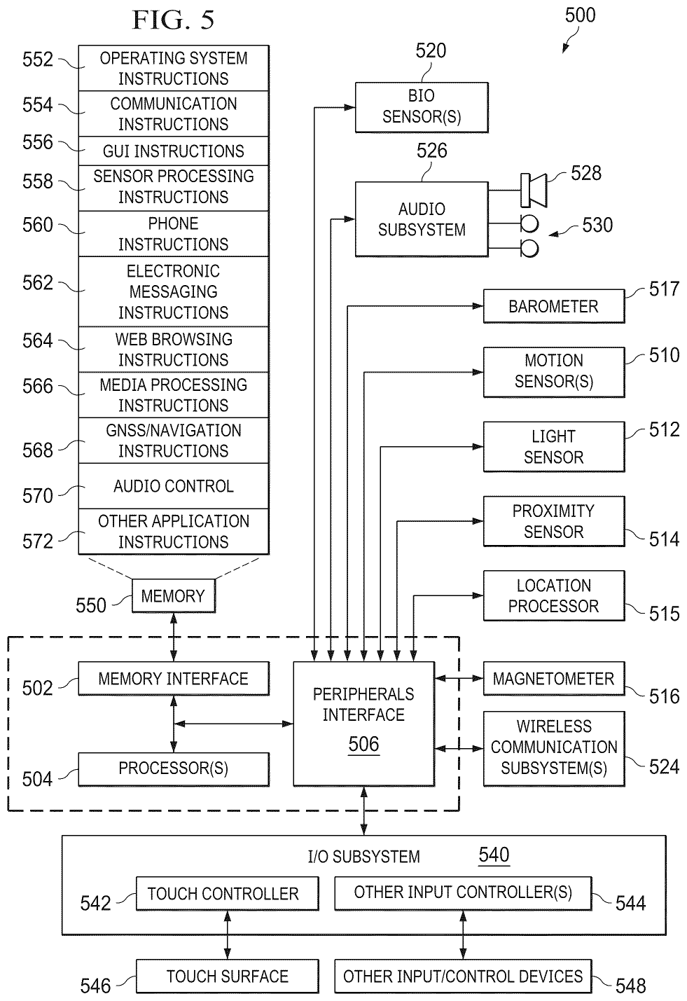

FIG. 4 is a flow diagram of a process 400 of active cancellation of parasitic vibration from motion sensor signals, according to one or more embodiments. Process 400 can be implemented in, e.g., device architecture 500 described in reference to FIG. 5.

Process 400 includes: obtaining a motion sensor signal from a motion sensor (401); obtaining a reference signal indicative of parasitic vibration from a vibration source mechanically coupled to the motion sensor (402); generating, using an adaptive noise canceller, an estimate of the parasitic vibration (403); and using the estimated parasitic vibration to cancel the parasitic vibration from the motion sensor signal (404). Each of these steps were previously described in reference to FIG. 3.

### Example Device Architecture

FIG. 5 is a block diagram of a device architecture 500 for implementing the features and processes described in reference to FIGS. 1-4. Architecture 500 can include memory interface 502, one or more hardware data processors, image processors and/or processors 504 and peripherals interface 506. Memory interface 502, one or more processors 504 and/or peripherals interface 506 can be separate components or can be integrated in one or more integrated circuits. System architecture 500 can be included in any suitable electronic device for crash detection, including but not limited to: a smartwatch, smartphone, fitness band and any other device that can be attached, worn, or held by a user.

Sensors, devices, and subsystems can be coupled to peripherals interface 506 to provide multiple functionalities. For example, one or more motion sensors 510, light sensor 512 and proximity sensor 514 can be coupled to peripherals interface 506 to facilitate motion sensing (e.g., acceleration, rotation rates), lighting and proximity functions of the wearable device. Location processor 515 can be connected to peripherals interface 506 to provide geo-positioning. In some implementations, location processor 515 can be a GNSS receiver, such as the Global Positioning System (GPS) receiver. Electronic magnetometer 516 (e.g., an integrated circuit chip) can also be connected to peripherals interface 506 to provide data that can be used to determine the direction of magnetic North. Electronic magnetometer 516 can provide data to an electronic compass application. Motion sensor(s) 510 can include one or more accelerometers and/or gyros configured to determine change of speed and direction of movement. Barometer 517 can be configured to measure atmospheric pressure (e.g., pressure change inside a vehicle). Bio signal sensor 520 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 524, which can include radio frequency (RF) receivers and transmitters (or transceivers) and/or optical (e.g., infrared) receivers and transmitters. The specific design and implementation of the communication subsystem 524 can depend on the communication network(s) over which a mobile device is intended to operate. For example, architecture 500 can include communication subsystems 524 designed to operate over a GSM network, a GPRS network, an EDGE network, a WiFi™ network and a Bluetooth™ network. In particular, the wireless communication subsystems 524 can include hosting protocols, such that the crash device can be configured as a base station for other wireless devices.

Audio subsystem 526 can be coupled to a speaker 528 and a microphone 530 to facilitate voice-enabled functions, such as voice recognition, voice replication, digital recording and telephony functions. Audio subsystem 526 can be configured to receive voice commands from the user.

I/O subsystem 540 can include touch surface controller 542 and/or other input controller(s) 544. Touch surface controller 542 can be coupled to a touch surface 546. Touch surface 546 and touch surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 546. Touch surface 546 can include, for example, a touch screen or the digital crown of a smart watch. I/O subsystem 540 can include a haptic engine or device for providing haptic feedback (e.g., vibration) in response to commands from processor 504. In an embodiment, touch surface 546 can be a pressure-sensitive surface.

Other input controller(s) 544 can be coupled to other input/control devices 548, such as one or more buttons, rocker switches, thumbwheel, infrared port, and USB port. The one or more buttons (not shown) can include an up/down button for volume control of speaker 528 and/or microphone 530. Touch surface 546 or other controllers 544 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 546; and a pressing of the button for a second duration that is longer than the first duration may turn power to the mobile device on or off. The user may be able to customize a functionality of one or more of the buttons. The touch surface 546 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 502 can be coupled to memory 550. Memory 550 can include high-speed random-access memory and/or non-volatile memory, such as one or more magnetic disk storage devices, one or more optical storage devices and/or flash memory (e.g., NAND, NOR). Memory 550 can store operating system 552, such as the iOS operating system developed by Apple Inc. of Cupertino, California. Operating system 552 may include instructions for handling basic system services and for performing hardware dependent tasks. In some implementations, operating system 552 can include a kernel (e.g., UNIX kernel).

Memory 550 may also store communication instructions 554 to facilitate communicating with one or more additional devices, one or more computers and/or one or more servers, such as, for example, instructions for implementing a software stack for wired or wireless communications with other devices. Memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GNSS/Location instructions 568 to facilitate generic GNSS and location-related processes and instructions; and instructions 570 that implement the processes described in reference to FIGS. 1-4. Memory 550 further includes other application instructions 572 including but not limited to instructions for applications that implement system 300 shown in FIG. 3.

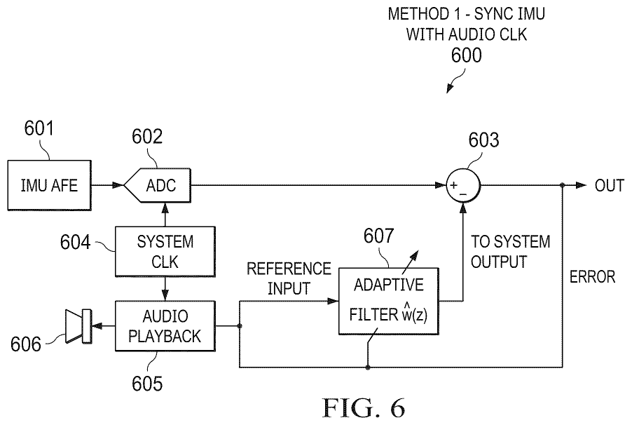

FIG. 6 is a flow diagram of system 600 for synchronizing an IMU module clock to a system clock, according to one or more embodiments. System 600 can be implemented in, for example, the device architecture 500 shown in FIG. 5.

System 600 includes IMU analog front end (AFE) 601, ADC 602, system clock 604, audio playback 605, loudspeaker 606, and adaptive noise canceller 607. IMU AFE 601 provides a motion signal to ADC 602 which converts the motion signal into voltage signals that represents the sensed motion. System clock 604 provides a clock to ADC 602 and audio playback 605 to ensure they synchronized to system clock 604. Audio playback 605 provides an audio waveform to loudspeaker 606, and a reference input indicative of parasitic vibration caused by loudspeaker 606 to adaptive noise canceller 607. Adaptive noise canceller 607 estimates the parasitic vibration so that it can be subtracted 603 from the motion signal, as shown in FIG. 3.

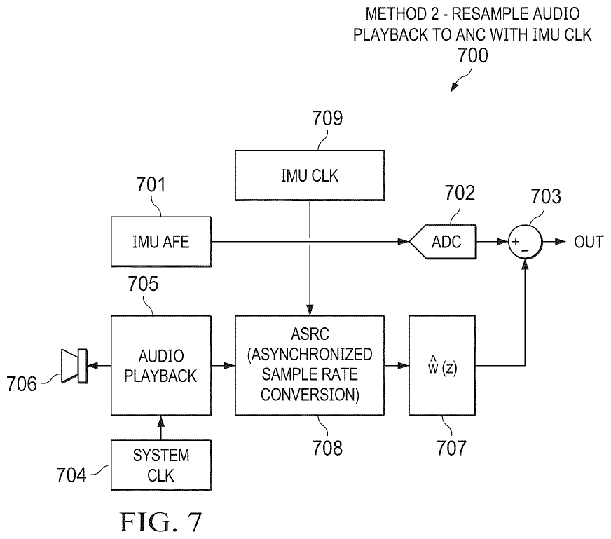

FIG. 7 is a block diagram of system 700 for synchronizing an IMU module clock to a system clock, according to one or more embodiments. System 700 can be implemented in, for example, the device architecture 500 shown in FIG. 5. System 700 includes IMU module AFE 701, ADC 702, system clock 704, audio playback 705, loudspeaker 706, adaptive filter 707, asynchronized sample rate converter (ASRC) 708 and IMU module clock 709.

IMU module clock 709 provides a clock to ASRC 708, which is coupled to audio playback 705. ASRC 708 also receives a reference input signal from audio playback 705 that represents parasitic vibration caused by loudspeaker 706. ASRC 708 adjusts the sample rate of the reference input and provides the adjusted reference input to adaptive filter 707. IMU AFE 701 provides motion signals to ADC 702, which converts the motion signal to voltages representing the motion signal. The adjusted reference input is provided by audio playback 705 to adaptive filter 707 which estimates the parasitic vibration, so that the parasitic vibration noise can be subtracted 703 from the motion signal, as previously described in reference to FIG. 3.

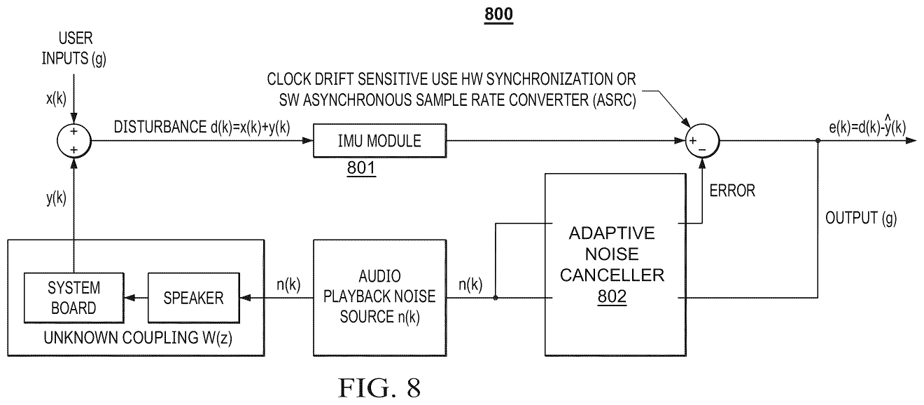

FIG. 8 is a conceptual block diagram of a system 800 for active cancellation of noise from motion sensor signals, where the subtraction of the estimated parasitic vibration from the motion signal occurs at the output of the IMU module 801, according to one or more embodiments. System 800 operates in the same manner as system 300, except that the subtraction of the estimated parasitic vibration output by the adaptive noise canceller 802 occurs at the output of IMU module 801. Note that the subtraction at the output of IMU module 801 is clock drift sensitive. According, the systems 600, 700 described in reference to FIGS. 6 and 7 can be used to reduce the sensitivity of system 800 to clock drift.

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method comprising:
obtaining a motion sensor signal from a motion sensor;
obtaining a reference signal indicative of parasitic vibration from a vibration source mechanically coupled to the motion sensor;
generating, using an adaptive noise canceller, an estimate of the parasitic vibration; and
using the estimated parasitic vibration to cancel the parasitic vibration from the motion sensor signal.

2. The method of claim 1, wherein the reference signal is proportional to the parasitic vibration.

3. The method of claim 1, wherein the reference signal is a music file that has been equalized or filtered.

4. The method of claim 1, wherein the reference signal is an analog signal.

5. The method of claim 1, wherein the adaptive noise canceller includes an adaptive filter, and coefficients of the adaptive filter are programmable.

6. The method of claim 1, wherein the vibration source is a loudspeaker.

7. The method of claim 1, wherein the vibration source is a haptic engine.

8. A system comprising:
at least one motion sensor configured to sense motion in at least one direction, and output a signal proportional to the sensed motion;
a voltage converter configured to convert the sensed motion into a voltage signal;
an analog-to-digital converter configured to convert the analog voltage signal into a digital signal; and
a disturbance estimator configured to estimate a disturbance signal included in the digital signal due to parasitic vibration generated by a vibration source mechanically coupled to the at least one motion sensor;
a subtraction unit configured to subtract the estimated disturbance signal from the digital signal; and
a processor configured to provide the digital signal to at least one application.

9. The system of claim 8, wherein the disturbance estimator is a digital active noise canceller that receives the digital signal and a digital reference input that is proportional to the disturbance, and iteratively computes the estimated disturbance signal based on an error between the digital signal and the estimated disturbance signal.

10. The system of claim 8, wherein the disturbance estimator is an analog active noise canceller that receives the voltage signal and an analog reference input that is proportional to the disturbance, and iteratively computes the estimated disturbance signal based on an error between the voltage signal and the estimated disturbance signal.

11. The system of claim 9, wherein the active noise canceller includes an adaptive filter, and coefficients of the adaptive filter are programmable.

12. The system of claim 8, where the system is included in a head mounted device and the at least one motion sensor senses motion of the head mounted device.

13. A system comprising:
a mounting platform;
at least one motion sensor mounted on the mounting platform and configured to sense motion in at least one direction, and output a signal proportional to the sensed motion;
a vibration source mechanically coupled to the mounting platform;
a controller that generates vibrations that also incur disturbances due to parasitic vibration generated by the vibration source, where the disturbance is mechanically coupled to the motion sensor through the mounting platform;
a voltage converter configured to convert the sensed motion into a voltage signal;
an analog-to-digital converter configured to convert the analog voltage signal into a digital signal; and
a disturbance estimator configured to estimate a disturbance signal included in the digital signal due to parasitic vibration generated by the vibration source mechanically coupled to the at least one motion sensor;
a subtraction unit configured to subtract the estimated disturbance signal from the digital signal; and
a circuit configured to provide the digital signal to at least one application.

14. The system of claim 13, wherein the disturbance estimator is a digital active noise canceller that receives the digital signal and a digital reference input that is proportional to the disturbance, and iteratively computes the estimated disturbance signal based on an error between the digital signal and the estimated disturbance signal.

15. The system of claim 14, wherein the active noise canceller includes an adaptive filter, and coefficients of the adaptive filter are programmable.

16. The system of claim 13, wherein the disturbance estimator is an analog active noise canceller that receives the voltage signal and an analog reference input that is proportional to the disturbance, and iteratively computes the estimated disturbance signal based on an error between the voltage signal and the estimated disturbance signal.

17. The system of claim 13, where the system is included in a head mounted device and the at least one motion sensor senses motion of the head mounted device.

18. A system comprising:
at least one motion sensor configured to sense motion in at least one direction, and output a signal proportional to the sensed motion;
a vibration source mechanically coupled to the motion sensor;
a controller configured to generate a reference signal proportional to a disturbance due to parasitic vibration generated by the vibration in response to receiving an audio waveform;
a voltage converter configured to convert the sensed motion into a voltage signal;
a disturbance estimator configured to estimate a disturbance signal included in the voltage signal due to parasitic vibration;
a subtraction unit configured to subtract the estimated disturbance signal from the voltage signal;
an analog-to-digital converter configured to convert the voltage signal into a digital signal; and
a circuit configured to provide the digital signal to at least one application.

19. The system of claim 18, wherein the disturbance estimator receives the voltage signal and reference voltage input that is proportional to the disturbance and determines the estimated disturbance signal based on an error between the voltage signal and the estimated disturbance signal.

20. The system of claim 18, where the system is included in a head mounted device and the at least one motion sensor senses motion of the head mounted device.
